(19) United States
(12) Patent Application Publication
(10) Pub. No.: US 2023/0357481 A1
(43) Pub. Date: Nov. 9, 2023

(54) COMPOSITION COMPRISING A COPOLYMER CONTAINING POLYAMIDE BLOCKS AND POLYETHER BLOCKS

(71) Applicant: ARKema FRANCE, Colombes (FR)

(72) Inventors: Blandine TESTUD, Serquigny (FR); Quentin PINEAU, Serquigny (FR); Florent ABGRALL, Serquigny (FR); Clio COCQUET, Colombes Cedex (FR)

(73) Assignee: ARKema FRANCE, Colombes (FR)

(21) Appl. No.: 18/245,171

(22) PCT Filed: Sep. 15, 2021
(86) PCT No.: PCT/FR2021/051579

§ 371 Date: Mar. 14, 2023

(30) Foreign Application Priority Data
Sep. 15, 2020 (FR) FR2009343

(51) Int. Cl. C08F 293/00; C08J 9/02

(52) U.S. Cl. CPC C08F 293/00; C08J 9/02; C08J 2353/00

(57) ABSTRACT

A composition including a copolymer containing polyamide blocks and polyether blocks including at least one carboxylic acid chain end having reacted with an epoxide function, the process for preparing same, and also the use thereof. A foam formed from this composition, the process for preparing same, and the use thereof.

### FIELD OF THE INVENTION

The present invention relates to a composition comprising a copolymer containing polyamide blocks and polyether blocks comprising at least one carboxylic acid chain end having reacted with an epoxide function, to the process for preparing same and also to the use thereof. The invention also relates to a foam formed from this composition, to the process for preparing same and to the use thereof.

### TECHNICAL BACKGROUND

Various copolymers containing polyamide blocks and polyether blocks are used notably in the field of sports equipment, such as soles or sole components, gloves, rackets or golf balls, personal protection items in particular for practising sports (jackets, interior parts of helmets, shells, etc.), because of their mechanical properties and in particular their excellent elastic return property. Specifically, these copolymers may be advantageously used in sports shoes as sole of semi-rigid type or flexible type making it possible to directly produce the insole and/or the outer sole.

However, it has been observed that copolymers containing polyamide blocks and polyether blocks, more particularly “flexible” copolymers, generally having a hardness of less than 55 Shore D, have limitations in terms of mechanical strength, typically abrasion resistance, tear strength and compressive strength.

They can also have limits in terms of adhesion when they are combined with other materials, such as for example polyurethane thermoplastics, in the production of multilayer structures by overmoulding processes.

There is a continuous market demand for materials that are more effective, namely materials with improved mechanical strength properties, in particular abrasion resistance, tear strength and compressive strength properties.

The objective of the present invention is therefore to provide compositions based on copolymers containing particular polyamide blocks and polyether blocks having one or more desired advantageous properties among good mechanical strength properties, in particular good abrasion resistance, tear strength and compressive strength properties, and better adhesion during overmoulding.

### SUMMARY OF THE INVENTION

The invention relates first of all to a composition comprising a copolymer containing polyamide blocks and polyether blocks (PEBA copolymer) comprising a carboxylic acid chain end of the polyamide block, which chain end is blocked by an epoxide function borne by an epoxide compound, the number-average functionality (Efn) of which is greater than 2, preferably greater than or equal to 3, and the epoxide equivalent weight (EEW) of which is from 80 to 700 g/mol, said composition having a complex viscosity (η*) which follows a power law as defined by the following equation:

η*=K (ω)^{n -1} (I)

in which:
K is a constant;
Ω is the angular frequency applied in oscillatory rheometry in the linear range at a temperature of 30° C. above the melting point of the composition according to ISO 6721-10; and
the value of n is between 0.55 and 0.95, preferentially between 0.60 and 0.90, even more preferentially between 0.65 and 0.85, or else between 0.70 and 0.85, over the range of angular frequencies w of between 0.135 and 1.35 rad/s.

In the context of the present invention, the melting point is measured by differential scanning calorimetry (DSC) with a heating rate of 20° C./min according to ISO 11357-1.

According to one embodiment, the polymer composition according to the invention has a weight-average molar mass (Mw) ranging from 80 000 to 300 000 g/mol, preferably from 90 000 to 250 000 g/mol, more preferentially from 100 000 to 200 000 g/mol.

According to one embodiment, the ratio of the weight-average molar mass (Mw) of the composition to the number-average molar mass (Mn) of the composition is greater than or equal to 2.4.

According to one embodiment, the ratio of the z-average molar mass (Mz) of the composition to the weight-average molar mass (Mw) of the copolymer is greater than or equal to 2, preferably greater than or equal to 2.5.

According to one embodiment, the polyamide (PA) blocks of the PEBA copolymer are chosen from blocks of PA 6, PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36 or PA 12.T, mixtures thereof, or copolyamides thereof, preferably blocks of PA 11, PA 12, PA 6, PA 6.10, PA 6.12, PA 10.10 or PA 10.12, or of mixtures thereof.

According to one embodiment, the polyether blocks of the PEBA copolymer are chosen from blocks of polyethylene glycol (PEG), of propylene glycol (PPG), of polytrimethylene glycol (PO3G), of polytetrahydrofuran (PTMG), or mixtures thereof, or copolymers thereof, preferably blocks of polyethylene glycol or of polytetrahydrofuran.

According to one embodiment:
the polyamide blocks of the PEBA copolymer have a number-average molar mass of from 400 to 20 000 g/mol, preferably from 500 to 10 000 g/mol; and/or
the polyether blocks of the PEBA copolymer have a number-average molar mass of from 100 to 6000 g/mol, preferably from 200 to 3000 g/mol.

According to one embodiment, the mass ratio of the polyamide blocks relative to the polyether blocks of the PEBA copolymer is from 0.1 to 20, preferably from 0.3 to 10, or from 0.3 to 5, or even more preferentially from 0.3 to 1.

In the context of the present invention, the number-average epoxide functionality (Efn) of the epoxide compound is greater than 2, advantageously greater than or equal to 3, and able to range up to 30. Preferably, the functionality (Efn) is from 3 to 20.

According to one embodiment, the epoxide equivalent weight (EEW) of the epoxide compound is from 80 to 700 g/mol, preferably from 80 to 100 g/mol, or from 100 to 200 g/mol, or 200 to 300 g/mol, or 300 to 400 g/mol, or 400 to 500 g/mol, or 500 to 600 g/mol, or 600 to 700 g/mol.

It has been observed that the composition of the invention has a thermoplastic nature and is recyclable.

The present invention thus provides a new type of composition, which notably has improved mechanical strengths, while at the same time having excellent recyclability properties.

This is accomplished by virtue of the use of a copolymer containing polyamide blocks and polyether blocks which is branched by a particular epoxy compound, having a particular complex viscosity.

The composition may also comprise at least one component (C) chosen from polyamides, functional polyolefins, copolyetheresters, thermoplastic polyurethanes (TPUs), copolymers of ethylene and of vinyl acetate, copolymers of ethylene and of acrylate, and copolymers of ethylene and of alkyl (meth)acrylate, and/or one or more additives (D) chosen from nucleating agents, fillers, notably mineral fillers, such as talc, reinforcing fibres, notably glass or carbon fibres, dyes, UV absorbers, antioxidants, notably phenolic antioxidants, or phosphorus-based or sulfur-based antioxidants, hindered amine light stabilizers or HALS, and mixtures thereof.

According to one embodiment, the melting point of the composition corresponds to the melting point of the PEBA copolymer.

In the case where several PEBA copolymers are present in the composition, the melting point of the composition corresponds to the highest melting point of the PEBA copolymers.

In the case where one or more components (C) are present in the composition, the melting point of the composition corresponds to the highest melting point of the PEBA copolymer(s) and of the component(s) (C).

According to one embodiment, the composition comprises from 0% to 49%, preferably from 0.1% to 49% by weight of at least one component (C) chosen from polyamides, functional polyolefins, copolyetheresters, thermoplastic polyurethanes (TPU), copolymers of ethylene and vinyl acetate, copolymers of ethylene and of acrylate, and copolymers of ethylene and of alkyl (meth)acrylate,
and/or from 0% to 10%, preferably from 0.1% to 10% by weight of one or more additives (D) chosen from nucleating agents, fillers, reinforcing fibres, dyes, UV absorbers, antioxidants, light stabilizers, and mixtures thereof, relative to the total weight of the composition.

The invention also relates to a process for producing a composition as described above, comprising a step of mixing, typically in the molten state, a PEBA copolymer, an epoxide compound, the epoxide equivalent weight (EEW) of which is from 80 to 700 g/mol, optionally one or more components (C) and/or one or more additives (D), so that at least one carboxylic acid chain end of the PEBA copolymer reacts with an epoxide function of the epoxide compound, said composition having a complex viscosity (η*) which follows a power law as defined by the following equation:

η*=K(ω)ⁿ⁻¹ (I)

in which:
K is a constant;
ω is the angular frequency applied in oscillatory rheometry in the linear range at a temperature of 30° C. above the melting point of the composition according to ISO 6721-10; and
the value of n is between 0.55 and 0.95, preferentially between 0.60 and 0.90, even more preferentially between 0.65 and 0.85, or else between 0.70 and 0.85, over the range of angular frequencies w of between 0.135 and 1.35 rad/s.

The PEBA copolymer typically has a carboxylic acid chain end content of from 10 to 200 μmol/g, preferably between 15 and 150 μmol/g, for example between 20 and 100 μmol/g.

The epoxide equivalent weight (EEW) of the epoxide compound is from 80 to 700 g/mol, preferably from 80 to 100 g/mol, or from 100 to 200 g/mol, or 200 to 300 g/mol, or 300 to 400 g/mol, or 400 to 500 g/mol, or 500 to 600 g/mol, or 600 to 700 g/mol.

According to one embodiment, the molar ratio of the carboxylic acid chain end content of the PEBA copolymer to the epoxide function content of the epoxide compound is typically between 2 and 20, preferably between 3 and 10.

According to one embodiment, the amount of the epoxide compound used in the process is from 0.01% to 5% by weight, preferably from 0.01% to 2% by weight, more preferably from 0.05% to 1% by weight, relative to the total weight of the PEBA copolymer.

According to one preferential embodiment, the amount of the epoxide compound used in the process is less than 1%, typically from 0.15% to 0.95%, preferably from 0.3% to 0.9%, or else from 0.35% to 0.85% by weight relative to the total weight of the PEBA copolymer.

The invention also relates to a composition that can be obtained according to the abovementioned process.

The present invention also relates to a foam of a composition as described above.

According to one embodiment, the foam has a density of less than or equal to 800 kg/m³, preferably less than or equal to 600 kg/m³, more preferentially less than or equal to 400 kg/m³, more preferentially still less than or equal to 300 kg/m³.

According to embodiments, the foam has a compression set (50% of deformation applied for 6 h at 50° C., measured according to Standard ISO 7214:2012, after 30 minutes of relaxation) of less than or equal to 65%, preferably less than or equal to 50%, or less than or equal to 45%, or less than or equal to 40%, or less than or equal to 35%.

The present invention provides a composition having an improved foamability and allowing the formation of a homogeneous, uniform polymer foam having a low density and having one or more advantageous properties from among: a high capacity for restoring elastic energy during low-stress loading; a low compression set (and therefore improved durability); a high fatigue strength in compression; excellent resilience properties, and notably abrasion resistance.

One of the advantages of the composition of the invention used in the foam according to the invention is that it has a non-crosslinked thermoplastic behaviour. Thus, the foam according to the invention is a non-crosslinked foam having the advantage of being recyclable.

A subject of the present invention is also the use of at least one epoxide compound as defined above in a PEBA block copolymer as defined above for improving the capacity of said copolymer to be converted into the form of a foam while at the same time retaining its recyclability.

The invention also relates to an article consisting of or comprising at least one element consisting of a composition as described above.

The invention also relates to an article consisting of or comprising at least one element consisting of a composition, typically a foam, as described above.

Advantageously, the article according to the invention is chosen from: a fibre, a fabric, a film, a sheet, a foam block, a foam particle, a rod, a tube, an injected-moulded and/or extruded part.

Advantageously, the article according to the invention is chosen from: footwear soles, large or small balls, gloves, personal protection equipment, rail tie pads, motor vehicle parts, construction parts and electrical and electronic equipment parts, for example the article is chosen from a footwear sole, in particular a sports footwear sole, such as an insole, midsole or outer sole, a ski boot liner, a sock, a racket, a small ball, a large ball, a floater, gloves, personal protection equipment, a helmet, a rail tie pad, a motor vehicle part, a pushchair part, a tyre, a wheel, a smooth-riding wheel such as a tyre, a handle, a seat element, a child car seat part, a construction part, an electrical and/or electronic equipment part, an electronic protection part, an audio equipment, acoustic insulation and/or heat insulation part, a part targeted at dampening impacts and/or vibrations, such as those generated by a means of transport, a padding element, a toy, a medical object, such as a splint, an orthosis, a cervical collar, a dressing, in particular an antimicrobial foam dressing, an art or handicraft object, a life jacket, a backpack, a membrane, a carpet, a sports mat, a sports floor covering, a carpet underlay, and any article comprising a mixture of these articles.

### DETAILED DESCRIPTION

The invention is now described in greater detail and in a nonlimiting way in the description which follows.

Unless otherwise indicated, all the percentages are mass percentages.

### Composition

The composition of the invention comprises a copolymer containing polyamide blocks and polyether blocks comprising at least one carboxylic acid chain end having reacted with an epoxide function.

In the context of the present invention, three types of polyamide blocks may advantageously be used for the PEBA copolymer.

According to a first type, the polyamide blocks originate from the condensation of a linear or branched aliphatic, cycloaliphatic or aromatic dicarboxylic acid, in particular those containing from 4 to 36 carbon atoms, preferably those containing from 6 to 18 carbon atoms, and of a linear or branched aliphatic, cycloaliphatic or alkylaromatic diamine, in particular those containing from 2 to 20 carbon atoms, preferably those containing from 4 to 14 carbon atoms.

According to one embodiment, the polyamide blocks originate from the condensation of a linear or branched aliphatic, cycloaliphatic or aromatic dicarboxylic acid and of a linear or branched aliphatic or cycloaliphatic diamine.

According to one embodiment, the polyamide blocks originate from the condensation of a linear or branched aliphatic or cycloaliphatic dicarboxylic acid and of a linear or branched aliphatic or cycloaliphatic diamine.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), para-aminodicyclohexylmethane (PACM), isophoronediamine (IPDA), 2,6-bis(aminomethyl)norbornane (BAMN) and piperazine (Pip).

Advantageously, polyamide blocks PA 4.12, PA 4.14, PA 4.18, PA 6.10, PA 6.12, PA 6.14, PA 6.18, PA 9.12, PA 10.10, PA 10.12, PA 10.14 and PA 10.18 are used. In the notation PA X.Y, X represents the number of carbon atoms derived from the diamine residues, and Y represents the number of carbon atoms derived from the diacid residues, as is conventional.

According to a second type, the polyamide blocks result from the condensation of one or more α,ω-aminocarboxylic acids and/or of one or more lactams containing from 6 to 12 carbon atoms in the presence of a dicarboxylic acid containing from 4 to 36 carbon atoms or of a diamine. As examples of lactams, mention may be made of caprolactam, oenantholactam and lauryllactam. As examples of α,ω-aminocarboxylic acids, mention may be made of aminocaproic acid, 7-aminoheptanoic acid, 11-aminoundecanoic acid and 12-aminododecanoic acid.

Advantageously, the polyamide blocks of the second type are PA 11 (polyundecanamide), PA 12 (polydodecanamide) or PA 6 (polycaprolactam) blocks. In the notation PA X, X represents the number of carbon atoms derived from amino acid residues.

According to a third type, the polyamide blocks result from the condensation of at least one α,ω-aminocarboxylic acid (or a lactam), at least one diamine of the abovementioned type and at least one dicarboxylic acid of the abovementioned type.

In this case, the polyamide PA blocks are prepared by polycondensation:
of the diamine(s) containing X carbon atoms;
of the dicarboxylic acid(s) containing Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y);
said comonomer(s) {Z} being introduced in a weight proportion advantageously ranging up to 50%, preferably up to 20%, even more advantageously up to 10% relative to the total amount of polyamide-precursor monomers;
in the presence of a chain limiter chosen from dicarboxylic acids.

Advantageously, the dicarboxylic acid containing Y carbon atoms is used as chain limiter, which is introduced in excess relative to the stoichiometry of the diamine(s).

According to one variant of this third type, the polyamide blocks result from the condensation of at least two α,ω-aminocarboxylic acids or from at least two lactams containing from 6 to 12 carbon atoms or from one lactam and one aminocarboxylic acid not having the same number of carbon atoms, in the optional presence of a chain limiter. As examples of aliphatic α,ω-aminocarboxylic acids, mention may be made of aminocaproic acid, 7-aminoheptanoic acid, 11-aminoundecanoic acid and 12-aminododecanoic acid. As examples of lactams, mention may be made of caprolactam, oenantholactam and lauryllactam. As examples of aliphatic diamines, mention may be made of hexamethylenediamine, dodecamethylenediamine and trimethylhexamethylenediamine. As examples of cycloaliphatic diacids, mention may be made of 1,4-cyclohexanedicarboxylic acid. As examples of aliphatic diacids, mention may be made of butanedioic acid, adipic acid, azelaic acid, suberic acid, sebacic acid, dodecanedicarboxylic acid and dimerized fatty acids. These dimerized fatty acids preferably have a dimer content of at least 98%; they are preferably hydrogenated; they are, for example, products sold under the brand name Pripol by Croda, or under the brand name Empol by BASF, or under the brand name Radiacid by Oleon, and polyoxyalkylene α,ω-diacids. As examples of aromatic diacids, mention may be made of terephthalic acid (T) and isophthalic acid (I). As examples of cycloaliphatic diamines, mention may be made of the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

As examples of polyamide blocks of the third type, mention may be made of the following:
PA 6.6/6, in which 6.6 denotes hexamethylenediamine units condensed with adipic acid and 6 denotes units resulting from the condensation of caprolactam;
PA 6.6/6.10/11/12, in which 6.6 denotes hexamethylenediamine condensed with adipic acid, 6.10 denotes hexamethylenediamine condensed with sebacic acid, 11 denotes units resulting from the condensation of aminoundecanoic acid, and 12 denotes units resulting from the condensation of lauryllactam.

The notations PA X/Y, PA X/Y/Z, etc. relate to copolyamides in which X, Y, Z, etc. represent homopolyamide units as described above.

Advantageously, the polyamide blocks of the copolymer used in the invention comprise polyamide PA 6, PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36 or PA 12.T blocks, or mixtures or copolymers thereof; and preferably comprise polyamide PA 6, PA 11, PA 12, PA 6.10, PA 10.10 or PA 10.12 blocks, or mixtures or copolymers thereof.

According to one embodiment, the polyamide blocks do not comprise aromatic units.

The polyether blocks are formed from alkylene oxide units.

The polyether blocks may notably be PEG (polyethylene glycol) blocks, i.e. blocks formed from ethylene oxide units, and/or PPG (polypropylene glycol) blocks, i.e. blocks formed from propylene oxide units, and/or PO3G (polytrimethylene glycol) blocks, i.e. blocks formed from trimethylene glycol ether units, and/or PTMG (polytetramethylene glycol) blocks, i.e. blocks formed from tetramethylene glycol units, also known as polytetrahydrofuran. The copolymers may comprise in their chain several types of polyethers, the copolyethers possibly being in block or statistical form.

Use may also be made of blocks obtained by oxyethylation of bisphenols, for instance bisphenol A. The latter products are notably described in document EP 613919.

According to one embodiment, the polyether blocks do not comprise polyether blocks derived from ethoxylated bisphenol.

The polyether blocks can also consist of ethoxylated primary amines. Mention may be made, as examples of ethoxylated primary amines, of the products of formula:

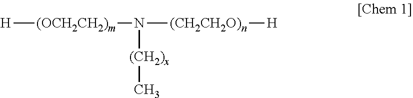

in which m and n are integers between 1 and 20, and x is an integer between 8 and 18. These products are for example commercially available under the brand name Noramox® from Arkema and under the brand name Genamin® from Clariant.

The polyether blocks may comprise α,ω-dihydroxylated aliphatic polyoxyalkylene blocks bearing OH chain ends (referred to as polyether diols).

The polyether blocks may comprise polyoxyalkylene blocks bearing diamine NH₂ chain ends (referred to as polyetheramine), such blocks being able to be obtained by cyanoacetylation of α,ω-dihydroxylated aliphatic polyoxyalkylene blocks referred to as polyether diols. More particularly, the commercial products Jeffamine or Elastamine may be used (for example Jeffamine® D400, D2000, ED 2003, XTJ 542, which are commercial products from Huntsman, also described in documents JP 2004346274, JP 2004352794 and EP 1482011).

According to one embodiment, the polyether blocks in the copolymer are polyether diols.

The polyether diol blocks are either used in unmodified form and copolycondensed with polyamide blocks bearing carboxylic end groups, or are aminated to be converted into polyetherdiamines and condensed with polyamide blocks bearing carboxylic end groups.

While the block copolymers described above comprise at least one polyamide block and at least one polyether block as described above, the present invention also covers the copolymers comprising three, four (or even more) different blocks, provided that these blocks include at least polyamide and polyether blocks.

For example, the copolymer according to the invention can be a segmented block copolymer comprising three different types of blocks (or “triblock” copolymer), which results from the condensation of several of the blocks described above. Said triblock may for example be a copolymer comprising a polyamide block, a polyester block and a polyether block or a copolymer comprising a polyamide block and two different polyether blocks, for example a PEG block and a PTMG block.

The PEBA copolymers result from the polycondensation of polyamide blocks bearing reactive ends with polyether blocks bearing reactive ends, such as, inter alia, the polycondensation:
1) of polyamide blocks bearing diamine chain ends with polyoxyalkylene blocks bearing dicarboxylic chain ends;
2) of polyamide blocks bearing dicarboxylic chain ends with polyoxyalkylene blocks bearing diamine chain ends, obtained, for example, by cyanoethylation and hydrogenation of α,ω-dihydroxylated aliphatic polyoxyalkylene blocks, known as polyether diols;
3) of polyamide blocks bearing dicarboxylic chain ends with polyether diols, the products obtained being, in this particular case, polyetheresteramides.

Preferably, the PEBA copolymers result from the polycondensation of polyamide blocks bearing dicarboxylic chain ends with polyether diols.

The polyamide blocks bearing dicarboxylic chain ends originate, for example, from the condensation of polyamide precursors in the presence of a chain-limiting dicarboxylic acid. The polyamide blocks bearing diamine chain ends originate, for example, from the condensation of polyamide precursors in the presence of a chain-limiting diamine.

PEBA copolymers that are particularly preferred in the context of the invention are copolymers including blocks from among: PA 11 and PEG; PA 11 and PTMG; PA 12 and PEG; PA 12 and PTMG; PA 6.10 and PEG; PA 6.10 and PTMG; PA 6 and PEG; PA 6 and PTMG.

The number-average molar mass of the polyamide blocks in the copolymer according to the invention is preferably from 400 to 20 000 g/mol, more preferentially from 500 to 10 000 g/mol, even more preferentially from 600 to 6000 g/mol. In embodiments, the number-average molar mass of the polyamide blocks in the copolymer is from 400 to 500 g/mol, or from 500 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol, or from 10 000 to 11 000 g/mol, or from 11 000 to 12 000 g/mol, or from 12 000 to 13 000 g/mol, or from 13 000 to 14 000 g/mol, or from 14 000 to 15 000 g/mol, or from 15 000 to 16 000 g/mol, or from 16 000 to 17 000 g/mol, or from 17 000 to 18 000 g/mol, or from 18 000 to 19 000 g/mol, or from 19 000 to 20 000 g/mol.

The number-average molar mass of the polyether blocks is preferably from 100 to 6000 g/mol, more preferentially from 200 to 3000 g/mol. In embodiments, the number-average molar mass of the flexible blocks is from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 4500 g/mol, or from 4500 to 5000 g/mol, or from 5000 to 5500 g/mol, or from 5500 to 6000 g/mol.

The number-average molar mass is set by the content of chain limiter. It can be calculated according to the relationship:

Mₙ=nₘₒₙₒₘₑᵣ×MW_{repeating unit}/n_{chain limiter}+MW_{chain limiter}

In this formula, nₘₒₙₒₘₑᵣ represents the number of moles of monomer, n_{chain limiter} represents the number of moles of chain limiter in excess, MW_{repeating unit} represents the molar mass of the repeating unit, and MW_{chain limiter} represents the molar mass of the chain limiter in excess.

The number-average molar mass of the polyamide blocks and of the polyether blocks can be measured before the copolymerization of the blocks by gel permeation chromatography (GPC).

Advantageously, the mass ratio of the polyamide blocks relative to the polyether blocks of the copolymer is from 0.1 to 20, preferably from 0.3 to 10, or from 0.3 to 5, or even more preferentially from 0.3 to 1. In particular, the mass ratio of the polyamide blocks relative to the polyether blocks of the copolymer may be from 0.1 to 0.2, or from 0.2 to 0.3, or from 0.3 to 0.4, or from 0.4 to 0.5, or from 0.5 to 0.6, or from 0.6 to 0.7, or from 0.7 to 0.8, or from 0.8 to 0.9, or from 0.9 to 1, or from 1 to 1.5, or from 1.5 to 2, or from 2 to 2.5, or from 2.5 to 3, or from 3 to 3.5, or from 3.5 to 4, or from 4 to 4.5, or from 4.5 to 5, or from 5 to 5.5, or from 5.5 to 6, or from 6 to 6.5, or from 6.5 to 7, or from 7 to 7.5, or from 7.5 to 8, or from 8 to 8.5, or from 8.5 to 9, or from 9 to 9.5, or from 9.5 to 10, or from 10 to 11, or from 11 to 12, or from 12 to 13, or from 13 to 14, or from 14 to 15, or from 15 to 16, or from 16 to 17, or from 17 to 18, or from 18 to 19, or from 19 to 20.

Preferably, the PEBA copolymer of the invention exhibits an instantaneous hardness of less than or equal to 72 Shore D, preferably less than or equal to 55 Shore D, even more preferentially less than or equal to 40 Shore D. The hardness measurements can be carried out according to Standard ISO 868:2003.

The composition of the invention has a weight-average molar mass Mw of greater than 80 000 g/mol. Preferably, the weight-average molar mass of the composition is from 80 000 to 300 000 g/mol, more preferentially from 90 000 to 250 000 g/mol, more preferentially still from 100 000 to 200 000 g/mol. The weight-average molar mass is expressed as PMMA equivalents (used as a calibration standard) and can be measured by size exclusion chromatography according to Standard ISO 16014-1:2012, the copolymer being dissolved in hexafluoroisoproponol stabilized with 0.05 M potassium trifluoroacetate for 24 h at ambient temperature at a concentration of 1 g/l to 2 g/l before being passed through the columns, for example at a flow rate of 1 ml/min, the molar mass being measured by a differential refractometer. The size exclusion chromatography can be carried out using columns of modified silica, for example on a set of two columns and a pre-column of modified silica (such as the PGF columns and pre-columns from Polymer Standards Service) comprising a 1000 Å column, having dimensions of 300×8 mm and a particle size of 7 μm, a 100 Å column, having dimensions of 300×8 mm and a particle size of 7 μm, and a pre-column having dimensions of 50×8 mm, for example at the temperature of 40° C.

In embodiments, the composition of the invention has a weight-average molar mass Mw ranging from 80 000 to 90 000 g/mol, or from 90 000 to 100 000 g/mol, or from 100 000 to 125 000 g/mol, or from 125 000 to 150 000 g/mol, or from 150 000 to 175 000 g/mol, or from 175 000 to 200 000 g/mol, or from 200 000 to 225 000 g/mol, or from 225 000 to 250 000 g/mol, or from 250 000 to 275 000 g/mol, or from 275 000 to 300 000 g/mol.

The composition of the invention may have a number-average molar mass Mn ranging from 30 000 to 100 000 g/mol, preferably from 35 000 to 80 000 g/mol, more preferentially from 40 000 to 70 000 g/mol. The number-average molar mass is expressed as PMMA equivalents and can be measured according to Standard ISO 16014-1 according to the method described above.

In embodiments, the composition has a number-average molar mass Mn ranging from 30 000 to 35 000 g/mol, or from 35 000 to 40 000 g/mol, or from 40 000 to 45 000 g/mol, or from 45 000 to 50 000 g/mol, or from 50 000 to 55 000 g/mol, or from 55 000 to 60 000 g/mol, or from 60 000 to 70 000 g/mol, or from 70 000 to 80 000 g/mol, or from 80 000 to 90 000 g/mol, or from 90 000 to 100 000 g/mol.

The composition can have a z-average molar mass Mz ranging from 200 000 to 1000 000 g/mol, preferentially between 300 000 and 800 000 g/mol. The z-average molar mass is expressed as PMMA equivalents and can be measured according to Standard ISO 16014-1 according to the method described above.

In embodiments, the composition has a z-average molar mass Mz ranging from 200 000 to 250 000 g/mol, or from 250 000 to 300 000 g/mol, or from 300 000 to 350 000 g/mol, or from 350 000 to 400 000 g/mol, or from 400 000 to 450 000 g/mol, or from 450 000 to 500 000 g/mol, or from 500 000 to 550 000 g/mol, or from 550 000 to 600 000 g/mol, or from 600 000 to 650 000 g/mol, or from 650 000 to 700 000 g/mol, or from 700 000 to 750 000 g/mol, or from 750 000 to 800 000 g/mol, or from 800 000 to 850 000 g/mol, or from 850 000 to 900 000 g/mol, or from 900 000 to 950 000 g/mol, or from 950 000 to 1 000 000 g/mol.

The polydispersity of the composition can be defined by the ratio of the weight-average molar mass Mw of the composition to the number-average molar mass Mn of the composition (Mw/Mn molar mass ratio) and/or by the ratio of the z-average molar mass Mz of the composition to the weight-average molar mass Mw of the composition (Mz/Mw molar mass ratio).

The composition according to the invention has an Mw/Mn molar mass ratio of greater than or equal to 2.4. In embodiments, the copolymer has an Mw/Mn molar mass ratio of greater than or equal to 2.5, or greater than or equal to 2.6, or greater than or equal to 2.7, or greater than or equal to 2.8, or greater than or equal to 2.9, or greater than or equal to 3.

The composition according to the invention may have an Mz/Mw molar mass ratio of greater than or equal to 2, preferably greater than or equal to 2.5. In embodiments, the composition has an Mz/Mw molar mass ratio of greater than or equal to 2.6, or greater than or equal to 2.7, or greater than or equal to 2.9, or greater than or equal to 3.1, or greater than or equal to 3.3, or greater than or equal to 3.5.

### Epoxide Compound

The epoxide compound of the invention has a number-average epoxide functionality (Efn) of greater than 2, advantageously greater than or equal to 3, and able to range up to 30. Preferably, the functionality (Efn) is between 3 and 20.

For the purposes of the present invention, the average epoxide functionality corresponds to the average number of epoxide functions per molecule of epoxide compound.

According to one embodiment, the epoxide equivalent weight (EEW) of the epoxide compound is from 80 to 700 g/mol.

According to one embodiment, the epoxide compound of the present invention is chosen from triglycidyl isocyanurate, trimethylolpropane triglycidyl ether, novolac epoxy resins, and epoxidized oils.

According to one embodiment, the epoxide compound of the present invention is chosen from random copolymers of (meth)acrylates bearing epoxide functions obtained by copolymerization of at least one (meth)acrylic monomer bearing an epoxide function with at least one monomer chosen from an alkene monomer, a vinyl acetate monomer, a non-functional (meth)acrylic monomer, a styrene monomer, or mixtures of one or more of these entities.

For the purposes of the present invention, the term (meth)acrylic monomer comprises both acrylic monomers and methacrylic monomers. Examples of (meth)acrylic monomers bearing an epoxide function comprise both acrylates and methacrylates. Examples of these (meth)acrylic monomers bearing an epoxide function comprise, but are not limited to, monomers containing 1,2-epoxide groups such as glycidyl acrylate and glycidyl methacrylate. Other suitable monomers may be allyl glycidyl ether, glycidyl ethacrylate and glycidyl itaconate.

The suitable alkene monomers may be, but without being limited thereto, ethylene, propylene, butylene, and mixtures of these entities.

The suitable acrylate and methacrylate monomers may be, but without being limited thereto, methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl methacrylate, i-amyl methacrylate, butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate and isobornyl methacrylate.

Styrene monomers include, but are not limited to, styrene, alpha-methylstyrene, vinyltoluene, p-methylstyrene, t-butylstyrene, o-chlorostyrene, vinylpyridine and mixtures of these entities. In certain embodiments, the styrene monomers for use in the present invention are styrene and alpha-methylstyrene.

According to one embodiment, the epoxide compound of the present invention is chosen from random copolymers of styrene-(meth)acrylate bearing epoxide functions, obtained from monomers of at least one (meth)acrylic monomer bearing an epoxide function and of at least one non-functional (meth)acrylic and/or styrene monomer.

In one embodiment, the epoxide compound contains between 25% and 50% by weight of at least one (meth)acrylic monomer bearing an epoxide function and 75% to 50% of at least one non-functional (meth)acrylic and/or styrene monomer. More preferentially, the epoxide compound contains between 25% and 50% by weight of at least one (meth)acrylic monomer bearing an epoxide function, between 15% and 30% by weight of at least one styrene monomer, and between 20% and 60% by weight of at least one non-functional acrylate and/or methacrylate monomer.

In one embodiment, the epoxide compound contains between 50% and 80% by weight, based on the total weight of the monomers, of at least one (meth)acrylic monomer bearing an epoxide function and 20% to 50% of at least one non-functional (meth)acrylic and/or styrene monomer. More preferentially, the epoxide compound contains between 50% and 80% by weight of at least one (meth)acrylic monomer bearing an epoxide function, and between 15% and 45% by weight of at least one styrene monomer, and between 0% and 5% by weight of at least one non-functional acrylate and/or methacrylate monomer.

In one embodiment, the epoxide compound contains between 5% and 25% by weight of at least one (meth)acrylic monomer bearing an epoxide function and 75% to 95% of at least one non-functional (meth)acrylic and/or styrene monomer. More preferentially, the epoxide compound contains between 5% and 25% by weight of at least one (meth)acrylic monomer bearing an epoxide function, between 50% and 95% by weight of at least one styrene monomer, and between 0% and 25% by weight of at least one non-functional acrylate and/or methacrylate monomer.

According to embodiments, the epoxide compound is chosen from styrene-(meth)acrylate copolymers bearing epoxide functions, obtained from monomers of at least one (meth)acrylic monomer bearing an epoxide function and of at least one non-functional (meth)acrylic and/or styrene monomer, preferably chosen from styrene-(meth)acrylate copolymers bearing epoxide functions, obtained from monomers of at least one (meth)acrylic monomer bearing an epoxide function and of at least one styrene monomer.

According to one embodiment, the epoxide compound is obtained from at least one (meth)acrylic monomer bearing an epoxide function and at least one styrene monomer. According to one embodiment, the epoxide compound contains from 50% to 80% by weight, relative to the total weight of the monomers, of at least one (meth)acrylic monomer bearing an epoxide function and between 20% and 50% by weight of at least one styrene monomer.

According to one preferential embodiment, the epoxide compound is a random copolymer of styrene and of glycidyl methacrylate.

The weight-average molar mass (Mw) of the copolymer of styrene-(meth)acrylate bearing epoxide functions is preferably less than 25 000 g/mol, more preferentially less than 20 000 g/mol; and is generally in the range of from 3000 to 15 000 g/mol, preferably from 5000 to 10 000 g/mol.

### Process for Preparing the Composition

The process of the invention may be a batch process or preferably a continuous process.

Typically, the process comprises a step of mixing in the molten state. The conditions applied to this step are chosen so as to allow intimate mixing of the compounds in the molten state.

According to one embodiment, a temperature which is at least 5° C. higher, preferably at least 10° C. higher, than the melting point of the composition is applied to the mixing step. This temperature should generally remain below 300° C., so as to avoid heat decomposition of the copolymer of the invention.

In the context of the present invention, one or more PEBA copolymers can be introduced. When a single PEBA copolymer is used, the temperature applied is at least 10° C. higher, preferably at least 30° C. higher, than the melting point of the copolymer. When several copolymers are used, the temperature applied is at least 10° C. higher, preferably at least 30° C. higher, than the highest melting point of the copolymers.

According to one embodiment, the temperature applied in the step of mixing in the molten state is greater than 200° C. and less than 300° C.

When one or more component(s) (C) are introduced during the mixing step, a temperature of at least 5° C. higher, preferably at least 10° C. higher than the highest melting point of the PEBA copolymer(s) and of the component(s) (C) is applied.

According to one embodiment, one or more additives are added during the mixing step of the preparation process.

Typically, the additives are chosen from stabilizers (for example antioxidants, notably phenolic antioxidants, or phosphorus-based or sulfur-based antioxidants, hindered amine light stabilizers or HALS, UV absorbers and/or flame retardants), fillers, notably mineral fillers, such as talc, reinforcing fibres, notably glass or carbon fibres, nucleating agents (for example CaCO₃, ZnO, SiO₂, or combinations of two or more thereof), demoulding agents, dyes, pigments (e.g. TiO₂ or other compatible coloured pigments), optical brighteners, photochromic additives, catalysts (e.g. zinc acetate, titanium acetate, magnesium acetate, calcium acetate), plasticizers and/or lubricants, or mixtures thereof.

According to one embodiment, from 0% to 10%, preferably 0.1% to 5% of additives relative to the total weight of the PEBA copolymer can be added in the mixing step of the process.

The process comprises a step of extruding the mixture in the molten state. The process may comprise a step of recovering the obtained product by cooling by means of a cooling liquid containing water, and/or a step of separating the cooling liquid and the cooled product and/or a step of shaping the cooled product in the form of rods or of ribbons, or directly in the form of granules.

As facility for carrying out the process of the invention, use may be made of any device for mixing, kneading or extruding molten plastics that is known to those skilled in the art. By way of examples, mention may be made of internal mixers, roll mills, counter-rotating or co-rotating single-screw or twin-screw extruders, continuous co-kneaders, or stirred reactors. The kneading device may be one of the tools mentioned above or a combination thereof, such as for example a co-kneader combined with a single-screw take-up extruder.

Preferably, all or part of the process according to the invention is carried out in a co-rotating twin-screw extruder.

Advantageously, the process is carried out by reactive extrusion, typically in an extruder.

### Foam

The foam as described above can be prepared by a production process comprising:
a step of providing a mixture comprising a composition as defined above, optionally with one or more additives, and a blowing agent; and
a step of foaming the mixture.

According to one embodiment, the mixture can comprise another component chosen from polyamides, functional polyolefins, copolyetheresters, thermoplastic polyurethanes (TPUs), copolymers of ethylene and vinyl acetate, copolymers of ethylene and of acrylate, and copolymers of ethylene and of alkyl (meth)acrylate. These components can be added preferably in a content of from 0% to 50% by weight, preferentially from 5% to 30% by weight, relative to the total weight of the mixture.

The blowing agent can be a chemical or physical agent, or else a mixture thereof. Preferably, it is a physical agent, for instance dinitrogen or carbon dioxide, or water, or a hydrocarbon, chlorofluorocarbon, hydrochlorocarbon, hydrofluorocarbon or hydrochlorofluorocarbon (saturated or unsaturated). For example, butane or pentane may be used.

A physical blowing agent can be mixed with the composition in liquid or supercritical form and then converted into the gaseous phase during the foaming step. The physical blowing agent may remain present in the pores of the foam, notably if it is a closed-pore foam, and/or may dissipate.

It can also be a chemical agent such as, for example, azodicarbonamide or mixtures based on citric acid and sodium hydrogen carbonate (NaHCO₃) (such as the products of the Hydrocerol® range from Clariant).

The foam thus formed consists essentially, or even consists, of the composition described above (or the mixture, if a mixture of polymers is used) and optionally the one or more additives which are dispersed in the matrix.

In the case where a chemical blowing agent is used, the foam may comprise, in addition to the composition described above (or the mixture, if a mixture of polymers is used), the decomposition products of the chemical blowing agent, said products being dispersed in the matrix.

Foaming techniques may be batch foaming, injection moulding foaming, extrusion foaming, such as single-screw or twin-screw extrusion foaming, autoclave foaming and microwave foaming.

According to one embodiment, the step of providing the mixture takes place in the molten state.

Advantageously, the process according to the invention comprises a step of injecting said mixture into a mould and a step of foaming said mixture. The foaming is produced either during the injection into the mould of a volume of polymer less than that of the mould, or by the opening of the mould. These two techniques, each or in combination, make it possible to directly produce three-dimensional foamed objects with complex geometries. They are also techniques that are relatively simple to perform, notably in comparison with certain processes of melting foamed particles as described in the prior art: specifically, filling of the mould with foamed polymer granules followed by melting of the particles to ensure a mechanical strength of the parts without destroying the structure of the foam are difficult operations.

Other injection moulding foaming techniques that can be used in the context of the present invention are notably injection moulding foaming with a breathable mould, with application of a gas backpressure, under metering, or with a mould equipped with a Variotherm® system.

According to one embodiment, the foaming process according to the invention comprises a step of providing the mixture in the molten state, and a step of extruding said mixture, inducing foaming of said mixture directly at the outlet of the extrusion die.

According to yet another embodiment, the foaming process comprises a step of impregnating a gas, typically an inert gas, into an object derived from a composition as described above, at a pressure above atmospheric pressure in order to force the introduction of the gas into the object, and a step of reducing the pressure allowing the gas to dissipate so as to produce the foam. In this case, the object may be typically a particle, an injection-moulded part or an extruded part from the composition.

As additives, mention may be made of pigments (TiO₂ and other compatible coloured pigments), adhesion promoters (for improving the adhesion of the expanded foam to other materials), fillers (for example calcium carbonate, barium sulfate and/or silicon oxide), nucleating agents (in pure form or in concentrated form, for example CaCO₃, ZnO, SiO₂, or combinations of two or more of them), rubbers (for improving the rubber elasticity, such as natural rubber, SBR, polybutadiene and/or ethylene propylene terpolymer), stabilizers, for example antioxidants, UV absorbers and/or flame retardants and processing aids, for example stearic acid. The additives can be added preferably in a content of from 0% to 10% by weight relative to the composition.

The foam according to the invention preferably has a density of less than or equal to 800 kg/m³, more preferentially less than or equal to 600 kg/m³, even more preferentially less than or equal to 400 kg/m³, and particularly preferably less than or equal to 300 kg/m³. It may, for example, have a density of from 25 to 800 kg/m³, and more particularly preferably from 50 to 600 kg/m³. The density may be controlled by adapting the parameters of the production process.

Preferably, this foam has a rebound resilience, according to Standard ISO 8307:2007, of greater than or equal to 50%, preferably greater than or equal to 55%.

Preferably, this foam has a compression set after 30 minutes of relaxation of 10 less than or equal to 65%, and more particularly preferably less than or equal to 50%, or less than or equal to 45%, or less than or equal to 40%, or less than or equal to 35%.

Preferably, this foam also has excellent properties in terms of fatigue strength and dampening.

Another advantage of the foam of the present invention provides better adhesion on the other elements in order to facilitate a complex assembly. This is particularly advantageous in the production of multilayer structures using overmoulding processes, for example in the context of the preparation of a footwear sole which is often in the form of multilayers.

The foam according to the invention may be used for producing sports equipment, such as sports shoe soles, ski shoes, midsoles, insoles or else functional sole components, in the form of inserts in the various parts of the sole (for example the heel or the arch), or else shoe upper components in the form of reinforcements or inserts into the structure of the shoe upper, or in the form of protections.

It may also be used for producing large balls, sports gloves (for example football gloves), golf ball components, rackets, protective elements (jackets, interior elements of helmets, shells, etc.).

The foam according to the invention has advantageous anti-impact, anti-vibration and anti-noise properties, combined with haptic properties suitable for equipment goods. It may thus also be used for producing railway rail tie pads, or various parts in the motor vehicle industry, in transport, in electrical and electronic equipment, in construction or in the production industry.

According to one embodiment, the foam articles according to the invention can be recycled, for example by melting them in an extruder equipped with a degassing outlet (optionally after having chopped them into pieces).

### Examples

The examples that follow illustrate the invention without limiting it.

Materials used:
PEBA 1: copolymer containing PA 11 blocks and PTMG blocks, the number-average molecular weights (Mn) of which are each 1000 g/mol. The content of acid chain end of the copolymer is 56 μmol/g.
PEBA 2: copolymer containing PA 12 blocks and PTMG blocks, the number-average molecular weights (Mn) of which are respectively 600 and 2000 g/mol. The content of acid chain end of the copolymer is 49 μmol/g.
Epoxide compound X: random copolymer of styrene and of glycidyl methacrylate. The weight-average molar mass Mw of the copolymer is 7100 g/mol. The epoxide equivalent weight (EEW) of the epoxide compound is 485 g/mol.
Epoxide compound Y: random copolymer of styrene and of glycidyl methacrylate. The weight-average molar mass Mw of the copolymer is 50 000 g/mol. The epoxy equivalent weight (EEW) of the epoxide compound is 917 g/mol.
Epoxide compound Z: Lotader AX8900, random terpolymer of ethylene, of glycidyl methacrylate and of maleic anhydride (68/8/24 by weight proportion). The epoxy equivalent weight (EEW) of the epoxide compound is 1775 g/mol.

### Preparation Process

The PEBA copolymer and the epoxide compound are mixed in the molten state in a reactive extrusion process in a co-rotating twin-screw extruder. The equipment used is a Coperion ZSK 26 MC extruder with a diameter of 26 mm and a length of 40 D. The materials are fed at a flow rate of 7.5 kg/h into the extruder, the screw speed of which is set at 300 rpm and the barrel temperature of which is set at 240° C. The product at the extruder outlet is granulated by cutting underwater.

Measurement methods:
Differential scanning calorimetry (DSC): In the context of the present invention, the melting point is measured by DSC with a heating rate of 20° C./min according to ISO 11357-1.
Rheology: the complex viscosity (η*) of the product is determined by oscillatory rheometry according to ISO 6721-10 with a plate-plate geometry with a diameter of 25 mm and a gap of 1 mm. The measurement is carried out in the linear range at 180° C. under a nitrogen purge. Over the range of angular frequencies ω of between 0.135 and 1.35 rd/s, the complex viscosity (η*) of the composition follows a power law as defined by the following equation:

η*=K(ω)ⁿ⁻¹

The measurements carried out make it possible to calculate the value of the coefficient n over this frequency range.
Solubility test: A solubilizing test is carried out by placing 0.5% of product in a solution of m-cresol at 100° C. for 2 h with stirring.
Size exclusion chromatography (or gel permeation chromatography): used to measure the number-average Mn, weight-average Mw and z-average Mz molar masses according to ISO 16014-1:2012. The product is solubilized in hexafluoroisoproponol stabilized with 0.05 M potassium trifluoroacetate for 24 h at ambient temperature at a concentration of 1 g/l. The solution obtained is then filtered through a PTFE membrane with a porosity of 0.2 μm, then injected at a flow rate of 1 ml/min into a liquid chromatography system equipped with a set of PFG columns from Polymer Standards Service consisting of a pre-column with dimensions of 50×8 mm, of a 1000 Å column, with dimensions of 300×8 mm and a particle size of 7 μm, and of a 100 Å column, with dimensions 300×8 mm and a particle size of 7 μm. The molar masses are measured by refractive index and are expressed as PMMA equivalents (PMMA being used as calibration standard).
Abrasion resistance: The product is injected at 220° C. in the form of sheets of 100×100×2 mm. The abrasion resistance thereof is measured according to ISO 9352:2012, and is expressed by the loss of weight associated with 1000 rotations of a 1 kg H18 grinding wheel.
Compression set: The product is injected at 220° C. in the form of cylinders with a diameter of 29.3 mm and a height of 12.7 mm. A compression strain of 25% is applied to the surface of the cylinders for 70 h at 23° C. according to ISO 815-1. After 30 minutes and then 24 h of relaxation, the compression set of the sample is measured.
Overmoulding: The overmoulding capacity of the product is evaluated in combination with TPU Elastollan 1195 A 10 000. An insert of the TPU with dimensions of 170×25×2 mm is first injected at 215° C. 24 h later, this cold insert is placed in an overmoulding mould. A new strip of 170×25×2 mm of the product is injected at 240° C. at the surface of the insert. 7 days after this forming, the interfacial adhesion measurement is carried out by free-corner peeling on a dynamometer according to ISO 8510-2. The ends of the 2 strips of TPU and of the composition are fixed to the jaws of the dynamometer which applies a tensile force of 50 mm/min. The force at equilibrium during the propagation of the decohesion is measured and characterizes the adhesion between the 2 overmoulded polymers.

### Results

The compositions of the examples are given as weight percentage:
Compositions A to F comprise PEBA 1.
Compositions G to K comprise PEBA 2.

TABLE 1

| | A | | | | E | F |
|---|---|---|---|---|---|---|
| | (counter- | B | C | D | (counter- | (counter |
| Composition | example) | (Ex) | (Ex) | (Ex) | example) | example) |
| PEBA 1 | 100 | 99.5 | 99.25 | 99 | 98 | 99 |
| Epoxide | 0 | 0.5 | 0.75 | 1 | 2 | |
| compound X | | | | | | |
| Epoxide | | | | | | 1 |
| compound Y | | | | | | |

| | G | | I | J | K |
|---|---|---|---|---|---|
| | (counter- | H | (counter- | (counter- | (counter |
| Composition | example) | (Ex) | example) | example) | example) |
| PEBA 2 | 100 | 99 | 99 | 90 | 80 |
| Epoxide | | 1 | | | |
| compound X | | | | | |
| Epoxide | | | 1 | 10 | 20 |
| compound Z | | | | | |

### Differential Scanning Calorimetry

TABLE 2

| DSC | A | B | C | D | E | F | G | H | I | J | K |
|---|---|---|---|---|---|---|---|---|---|---|---|
| Melting | 150 | 150 | 150 | 150 | 150 | 150 | 134 | 134 | 134 | 134 | 133 |
| point (° C.) | | | | | | | | | | | |

### Oscillatory Rheometry Measurement

The melting point of the various compositions is measured (Table 2). The measurement of the complex viscosity is carried out at Mp+30° C. (analysis) T°).

TABLE 3

| Angular frequency | Complex viscosity (Pa · s) | | | | | |
|---|---|---|---|---|---|---|
| (rad/s) | A | B | C | D | E | F |
| Analysis T° (° C.) | 180 | 180 | 180 | 180 | 180 | 180 |
| 1.35 | 1.64E+03 | 3.33E+03 | 4.74E+03 | 4.99E+03 | 5.31E+03 | 1.81E+03 |
| 0.135 | 1.78E+03 | 5.53E+03 | 9.52E+03 | 1.13E+04 | 1.64E+04 | 2.01E+03 |
| n (0.13-1.35) | 0.98 | 0.78 | 0.70 | 0.65 | 0.51 | 0.96 |

TABLE 4

| Angular | | | | | |
|---|---|---|---|---|---|
| frequency | Complex viscosity (Pa · s) | | | | |
| (rad/s) | G | H | I | J | K |
| Analysis | 164 | 164 | 164 | 164 | 163 |
| T° (° C.) | | | | | |
| 1.35 | 0.76E+03 | 0.91E+03 | 0.82E+03 | 0.91E+03 | 1.11E+03 |
| 0.135 | 0.77E+03 | 1.22E+03 | 0.85E+03 | 0.98E+03 | 1.40E+03 |
| n (0.135- | 0.99 | 0.87 | 0.98 | 0.97 | 0.90 |
| 1.35) | | | | | |

Composition A (100% linear PEBA 1 copolymer, Counterexample) exhibits a Newtonian plateau at low frequencies (ω=0.135-1.35) which corresponds to a value of n=0.98. The compositions of the invention B, C and D exhibit values of n of 0.78, 0.70 and 0.65. Composition E exhibits a value of n at 0.51.

Composition F exhibits a Newtonian plateau at low frequencies (ω=0.135-1.35) which corresponds to a value of n=0.96.

Composition G (100% linear PEBA 2 copolymer, Counterexample) exhibits a Newtonian plateau at low frequencies (ω=0.135-1.35) which corresponds to a value of n=0.99. The composition of the invention H exhibits a value of n at 0.87.

### Solubilization Test

TABLE 5

| | A | B | C | D | E | F |
|---|---|---|---|---|---|---|
| m-Cresol solubility | yes | yes | yes | yes | no | yes |

| | G | H | I | J | K |
|---|---|---|---|---|---|
| m-Cresol solubility | yes | yes | yes | yes | yes |

It was observed that compositions, on the one hand, B to D and, on the other hand, F to K remain soluble in m-cresol, thereby illustrating their thermoplastic and recycable behaviour.

Conversely, composition E is not soluble, thereby confirming the crosslinking thereof.

### Chromatography: Mn, Mw and Mz Masses

TABLE 6

| | A | B | C | D |
|---|---|---|---|---|
| Mn | 41 040 | 46 080 | 43 610 | 42 680 |
| Mw | 91 760 | 125 900 | 147 300 | 167 800 |
| Mz | 165 000 | 482 900 | 592 400 | 774 800 |
| Mw/Mn | 2.24 | 2.73 | 3.38 | 3.93 |
| Mz/Mw | 1.80 | 3.84 | 4.02 | 4.62 |

Compositions B, C and D according to the invention have weight-average (Mw) and z-average (Mz) molar masses that are higher compared to composition A. That illustrates a wider molecular weight distribution of compositions B, C and D, which results in higher values of the dispersity indices Mw/Mn and Mz/Mw.

### Abrasion Resistance

TABLE 7

| Abrasion | A | B | C | D | F | G | H | I | J | K |
|---|---|---|---|---|---|---|---|---|---|---|
| Weight loss | 55 | 41 | 46 | 51 | 56 | 131 | 118 | 132 | 147 | 162 |
| (mg) | | | | | | | | | | |

Compositions B, C and D according to the invention have a better abrasion resistance compared to comparative example A and to comparative example F.

Composition H according to the invention has a better abrasion resistance compared to comparative examples G and I to K.

### Compression Strength

TABLE 8

| | Compression set (%) | | | | | | | | | |
|---|---|---|---|---|---|---|---|---|---|---|
| | A | B | C | D | F | G | H | I | J | K |
| After 30 min | 39.7 | 37.9 | 34.4 | 38.7 | — | — | — | — | — | — |
| After 24 h | 30.1 | 28.2 | 27.1 | 29.0 | 30.4 | 19.3 | 18.1 | 19.5 | 21.4 | 23.6 |

Compositions B, C and D according to the invention have a lower compression set compared to composition A and to comparative example F. They therefore exhibit a better compression strength.

Composition H according to the invention has a better abrasion resistance compared to comparative examples G and I to K, and therefore exhibits a better compression strength.

### Overmoulding

TABLE 9

| | A | D |
|---|---|---|
| Peel force on TPU (N/cm) | 238 | 265 |

It was observed that composition D has a better adhesion during overmoulding on a TPU support.

Thus, the compositions of the invention have improved properties in terms of mechanical strength, notably abrasion resistance and compression strength, and better adhesion during overmoulding.

1. Composition comprising a copolymer containing polyamide blocks and polyether blocks (PEBA copolymer) comprising a carboxylic acid chain end of the polyamide block, which chain end is blocked by an epoxide function borne by an epoxide compound, the number-average functionality (Efn) of which is greater than 2, and the epoxide equivalent weight (EEW) of which is from 80 to 700 g/mol, said composition having a complex viscosity (η*) which follows a power law as defined by the following equation:
η*=K(ω)ⁿ⁻¹ (I)
in which:
K is a constant;
ω is the angular frequency applied in oscillatory rheometry in the linear range at a temperature of 30° C. above the melting point of the composition according to ISO 6721-10; and
the value of n is between 0.55 and 0.95, over the range of angular frequencies ω of between 0.135 and 1.35 rad/s.

2. Composition according to claim 1, having a weight-average molar mass (Mw) ranging from 80 000 to 300 000 g/mol.

3. Composition according to claim 1, in which the ratio of the weight-average molar mass (Mw) to the number-average molar mass (Mn) is greater than or equal to 2.4, and/or the ratio of the z-average molar mass (Mz) to the weight-average molar mass Mw is greater than or equal to 2.

4. Composition according to claim 1, in which the polyamide PA block is chosen from blocks of PA 6, PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36 or PA 12.T, mixtures thereof, or copolyamides thereof, and/or the polyether block is chosen from PEG, PPG, PO3G, PTMG, mixtures thereof or copolymers thereof.

5. Composition according to claim 1, in which the PEBA copolymer results from the polycondensation of polyamide blocks bearing dicarboxylic chain ends with polyether diols.

6. Composition according to claim 1, in which the epoxide compound is chosen from random copolymers of (meth)acrylates bearing epoxide functions obtained by copolymerization of at least one (meth)acrylic monomer bearing an epoxide function with at least one monomer chosen from an alkene monomer, a vinyl acetate monomer, a non-functional (meth)acrylic monomer, a styrene monomer, or mixtures of one or more of these entities.

7. Composition according to claim 1, also comprising at least one component (C) chosen from polyamides, functional polyolefins, copolyetheresters, thermoplastic polyurethanes (TPUs), copolymers of ethylene and of vinyl acetate, copolymers of ethylene and of acrylate, and copolymers of ethylene and of alkyl (meth)acrylate, and/or one or more additives (D) chosen from nucleating agents, fillers, notably mineral fillers, reinforcing fibres, notably glass or carbon fibres, dyes, UV absorbers, antioxidants, notably phenolic antioxidants, or phosphorus-based or sulfur-based antioxidants, hindered amine light stabilizers or HALS, and mixtures thereof.

8. Process for producing a composition according to claim 1, comprising a step of mixing, typically in the molten state, a PEBA copolymer, an epoxide compound, the epoxide equivalent weight (EEW) of which is from 80 to 700 g/mol, optionally one or more component(s) (C) and/or one or more additives (D), so that at least one carboxylic acid chain end of the PEBA copolymer reacts with an epoxide function of the epoxide compound, said composition having a complex viscosity (η*) which follows a power law as defined by the following equation:
η*=K(ω)ⁿ⁻¹ (I)
in which:
K is a constant;
ω is the angular frequency applied in oscillatory rheometry in the linear range at a temperature of 30° C. above the melting point of the composition according to ISO 6721-10; and
the value of n is between 0.55 and 0.95 or else between 0.70 and 0.85, over the range of angular frequencies ω of between 0.135 and 1.35 rad/s.

9. Process according to claim 8, in which the PEBA copolymer has a carboxylic acid chain end content of from 10 to 200 μmol/g.

10. Process according to claim 8, in which the molar ratio of the carboxylic acid chain end content of the PEBA copolymer to the epoxide function content of the epoxide compound is typically between 2 and 20.

11. Process according to claim 8, in which the process is carried out by reactive extrusion, typically in an extruder.

12. Composition that can be obtained according to the process of claim 8.

13. Foam of a composition according to claim 1.

14. Article consisting of or comprising at least one element consisting of a composition as defined in claim 1.

15. Article according to claim 14, constituting at least a part of one of the following articles: sports article, shoe component, sports shoe component, shoe sole, notably studs, ski component, notably ski boot or ski boot shell, sports tool, ice skates, ski attachments, rackets, sports bats, boards, horseshoes, protective leggings, flippers, golf balls, leisure article, DIY article, road maintenance tool or equipment, protective equipment or article, helmet visors, goggles, goggle arms, motor vehicle part, car component, dashboard, airbag, headlamp protector, rear-view mirror, small part for off-road vehicles, tank, scooters, mopeds or motorbikes, industrial component, industrial additive, electrical, electronic, information technology, tablet computer, telephone or computer component, safety accessory, shop sign, lighting strip, information and publicity panel, presentation case, engraving, furnishing, shopfitting, decoration, contact ball, medical device, dental prosthesis, implant, ophthalmology article, hemodialysis machine membrane, optical fibres, art object, sculpture, photography camera lenses, disposable photography camera lenses, printing support, notably support for direct printing with UV inks, for photography table, window, sunroof, transmission belt, antistatic additive, waterproof breathable product or film, active molecule support, colourant, welding agent, decorative element, and/or polyamide additive, rail sole, pushchair component, wheel, handle, seat component, child car seat component, construction component, audio equipment, acoustic insulation and/or heat insulation component, component for absorbing impacts and/or vibrations, smooth-riding wheels, textile, woven or nonwoven, wrapping, peristaltic belt, conveyor belt, synthetic skin and/or leather.
